(19) United States
(12) Patent Application Publication
(10) Pub. No.: US 2014/0310536 A1
(43) Pub. Date: Oct. 16, 2014

(54) STORAGE DEVICE ASSISTED INLINE ENCRYPTION AND DECRYPTION

(71) Applicant: Qualcomm Incorporated, San Diego, CA (US)

(72) Inventor: Assaf Shacham, Zichron Yaakov (IL)

(73) Assignee: Qualcomm Incorporated, San Diego, CA (US)

(21) Appl. No.: 14/244,742

(22) Filed: Apr. 3, 2014

Related U.S. Application Data
(60) Provisional application No. 61/812,616, filed on Apr. 16, 2013.

(51) Int. Cl. G06F 21/78

(52) U.S. Cl. CPC G06F 21/78
USPC 713/193

(57) ABSTRACT

Various features pertain to inline encryption and decryption. In one aspect, inline read/write operations are performed by configuring an off-chip storage device to provide parameters to facilitate inline encryption/decryption of data by a host storage controller of a system-on-a-chip (SoC.) The parameters provided by the storage device to the host storage controller include an identifier that is the same for read and write operations for a particular block of data but differs from one block of data to another. The host storage controller employs the parameters as initial vectors to generate encryption keys for use in encrypting/decrypting data. Exemplary read and write operations of the host storage controller and the off-chip storage device are described herein. Examples are also described wherein the parameters are obtained from host memory rather than from the storage device.

### CLAIM OF PRIORITY UNDER 35 U.S.C. §119

The present application for patent claims priority to Provisional Application No. 61/812,616 entitled “DEVICE ASSISTED INLINE STORAGE ENCRYPTION” filed Apr. 16, 2013, which is assigned to the assignee hereof and hereby expressly incorporated by reference herein.

### BACKGROUND

1. Field

The present disclosure pertains to host storage controllers for use with external storage devices and, in particular, to inline encryption and decryption of data.

2. Background

In order to secure data, such data is often encrypted during transmission and/or when stored. In one example, the data is stored in an external storage device connected via a storage bus to a host system-on-a-chip (SoC.) A typical SoC may include an application processing circuit and a host storage controller, which is a hardware element of the SoC. The application processing circuit executes host software that serves to initiate read/write transactions to/from an external storage device. For example, the host software component may order the host storage controller to issue the read/write transactions to the external storage device. The host storage controller, in turn, communicates with the external storage device over the storage bus to copy data to/from the storage device and then notifies the host software of completion of such operations. The host storage controller may also access a host memory via a separate memory bus. Typically, the host memory is a generally more secure memory protected from malicious attacks, whereas the external storage device is a generally less secure off-chip memory device vulnerable to such attacks. Hence, data stored in the external storage device may need to be encrypted, whereas data stored in the host memory generally need not be encrypted. The encryption process may require parameters which are not available to the host storage controller. Within such systems, the host storage controller typically operates as a channel with limited command decoding (or none at all). The complexity of read/write operations (e.g., command generation/decoding and access optimization) resides in the host software and in firmware executed by the storage device. Accordingly, to secure data stored in the external storage device, encryption/decryption of the data is typically performed by the host software and/or the storage device, rather than by the host storage controller.

However, a solution is needed that instead permits efficient inline encryption/decryption by the host storage controller.

### SUMMARY

A method operational at a host storage controller to encrypt data during a write operation to a storage device external to the host storage controller includes: obtaining a write command from a requesting host software component to write data to the storage device; sending the write command to the storage device; obtaining a parameter associated with the data from the storage device; generating an encryption key based on the parameter; and encrypting the data using the encryption key.

In another aspect, a method operational at a host storage controller to decrypt data during a read operation from a storage device external to the host storage controller includes: obtaining a read command from a requesting host software component to read data from the storage device; sending the read command to the storage device; obtaining encrypted data and a parameter associated with the encrypted data from the storage device; generating a decryption key based on the parameter; and decrypting the encrypted data using the decryption key.

In yet another aspect, a device includes a storage device to store data and a processing circuit coupled to the storage device, the processing circuit having a host storage controller configured to: obtain a write command from a requesting host software component to write data to the storage device; send the write command to the storage device; obtain a parameter associated with the data from the storage device; generate an encryption key based on the parameter; and encrypt the data using the encryption key.

In still yet another aspect, a device includes a storage device to store data and a processing circuit coupled to the storage device, the processing circuit having a host storage controller configured to: obtain a read command from a requesting host software component to read data from the storage device; send the read command to the storage device; obtain encrypted data and a parameter associated with the encrypted data from the storage device; generate a decryption key based on the parameter; and decrypt the encrypted data using the decryption key.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates an exemplary system-on-a-chip (SoC) with inline encryption/decryption.

FIG. 2 illustrates an exemplary application processing circuit, a host storage controller and an external storage device and information exchanged there-between.

FIG. 3 illustrates an exemplary SoC in greater detail wherein the SoC includes a host storage controller equipped for storage device assisted inline encryption/decryption.

FIG. 4 illustrates an exemplary inline encryption/write operation that may be performed by the host storage controller in conjunction with an off-chip storage device.

FIG. 5 illustrates exemplary inline encryption/write operations performed between a host storage controller and an off-chip storage device.

FIG. 6 illustrates exemplary register and host memory spaces for use with transaction queuing for a universal flash storage (UFS) implementation of the storage device assisted inline encryption/decryption.

FIG. 7 illustrates an exemplary UFS transfer request descriptor (UTRD) for use with the implementation of FIG. 6 wherein the UTRD includes a key index.

FIG. 8 illustrates an exemplary ready to transfer (RTT) UFS protocol information unit (UPIU) for use with the implementation of FIG. 6 wherein the UPIU includes a logical block address (LBA) indicator and a block count indictor.

FIG. 9 illustrates an exemplary inline decryption/read operation that may be performed by the host storage controller in conjunction with the off-chip storage device.

FIG. 10 illustrates exemplary inline decryption/read operations performed between a host storage controller and an off-chip storage device.

FIG. 11 illustrates an exemplary “data in” UPIU for use with the implementation of FIG. 10 wherein the UPIU includes an LBA indicator and a block count indictor.

FIG. 12 is a block diagram illustrating an example of a hardware implementation for an apparatus employing a processing system that may exploit the systems, methods and apparatus of FIGS. 1-11.

FIG. 13 is a block diagram illustrating exemplary components of the processing circuit of FIG. 12.

FIG. 14 is a block diagram illustrating exemplary instruction components of the machine-readable medium of FIG. 12.

FIG. 15 illustrates a method operational at the host storage controller to encrypt data during a write operation into a storage device.

FIG. 16 illustrates a method operational at the host storage controller to decrypt data during a read operation from a storage device.

FIG. 17 illustrates a method operational at a storage device to facilitate data encryption during a write operation by a host storage controller.

FIG. 18 illustrates a method operational at a storage device to facilitate data decryption during a read operation by a host storage controller.

FIG. 19 illustrates an alternative method operational at the host storage controller to encrypt data during a write operation into a storage device.

FIG. 20 illustrates an alternative method operational at the host storage controller to decrypt data during a read operation from a storage device.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several novel features pertain to storage device assisted inline encryption and decryption. In one aspect, inline read/write operations are performed by configuring an off-chip storage device to provide parameters to facilitate inline encryption/decryption of data by a host storage controller of a system-on-a-chip (SoC.) In various examples described herein, the parameters obtained by the host storage controller from the off-chip storage device provide an identifier that is the same for read and write operations for a particular block of data but differs from one block of data to another. A particular example of such a parameter is the logical block address (LBA) obtained from the storage device for the data to be encrypted/decrypted. However, other parameters may be used in addition to, or instead of, the LBA to provide enhanced security. To providing concrete examples herein of inline encryption/decryption procedures, some of the following descriptions are directed to implementations where the LBA is used, but it should be understood that other parameters may be used, in addition to, or as an alternative to, the LBA.

The host storage controller uses the parameters obtained from the storage device to generate or otherwise obtain keys for use in encrypting/decrypting data, thus alleviating the need for other components of the SoC to perform or control such functions to thereby provide more efficient inline encryption/decryption. In an example where the LBA is obtained by the host storage controller from the storage device, the LBA is used as an initial vector (or initialization vector) for use in encryption/decryption. This procedure is distinct from inline encryption/decryption systems that would otherwise obtain the initial vector from a source other than the off-chip storage device, such as by attempting to extract such information from read/write commands received from host software. Note also that by using the LBA as the initial vector, the initial vector will be the same for both write/encryption operations and read/decryption operations, thereby allowing the host storage controller to decrypt data that had been previously encrypted and stored in the off-chip storage device. Moreover, the initial vector will be different for each block of data, thereby providing a unique initial value for each block of data. Still further, by obtaining the LBA or other suitable parameters from the off-chip storage device for use as the initial vector, initial vector information need not be stored in the on-chip memory, thus saving valuable on-chip storage space. Note also that, typically, a host storage controller is not provided with the actual storage address used by an off-chip storage device but is instead provided only with the host memory address for the data, which can differ between read and write operations to the same data. Hence, host memory addresses typically cannot be used for inline encryption/decryption. In this regard, the addresses used by the storage device (whether physical or logical) are within a different address space from the memory addresses used by the host processor. Conventionally, the host storage controller does not receive, and hence cannot use, storage addresses from the off-chip storage device for use in encryption/decryption.

Some examples described herein include read and write operations performed generally in accordance with UFS host controller interface standards of the JEDEC Solid State Technology Association, formerly known as the Joint Electron Device Engineering Council (JEDEC). See, for example, the JESD220A and JESD223A standards documents of June 2012. The JEDEC UFS read and write operations are modified, as described below, to provide various features disclosed herein. It should be understood, however, that at least some of the features described herein may be implemented in other systems that do not generally conform to JEDEC standards, including proprietary or other systems.

Exemplary Device(s) with Inline Write Encryption and Read Decryption

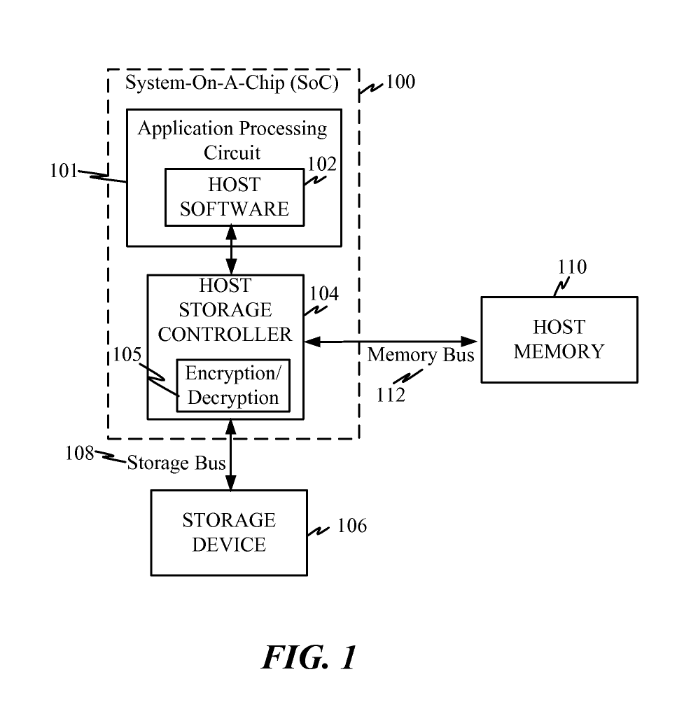

FIG. 1 broadly illustrates an exemplary system on a chip 100 with inline encryption/decryption. Briefly, the SoC 100 includes an application processing circuit 101 equipped to execute host software or software components 102 and further including a host storage controller 104. In this example, the host storage controller 104 includes an inline encryption/decryption module 105 that is capable of encrypting data written into an external storage device 106 via the storage bus 108 and/or decrypting data read from the storage device 106 via the same storage bus. These operations may be performed in conjunction with data or other parameters stored within a host memory 110 accessed via a memory bus 112. To facilitate operations performed by the encryption/decryption module 105, the storage device 106 is configured to provide parameters (such as LBA values) to the host storage controller 104 during read and write operations.

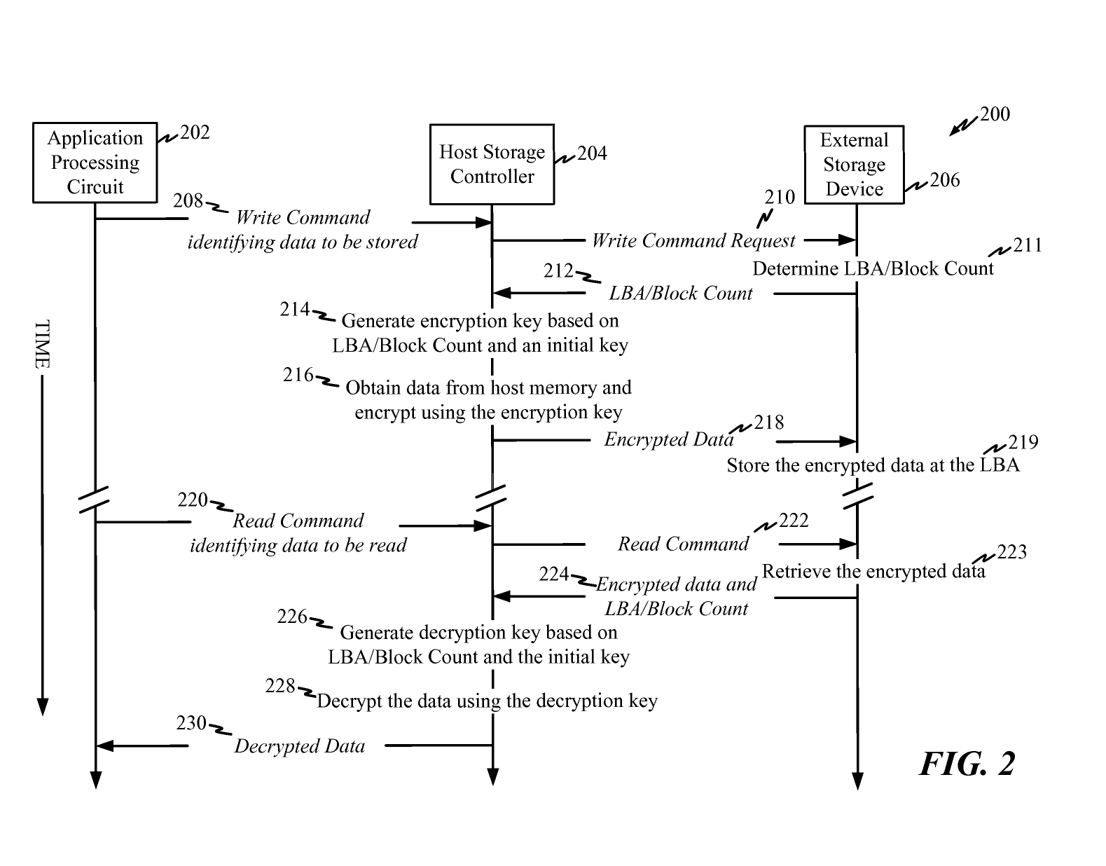

FIG. 2 provides a timing diagram 200 illustrating exemplary read and write operations of an application processing circuit 202, a host storage controller 204 and an external storage device 206 and particularly illustrating information exchanged there-between for use with inline encryption/decryption. Processing begins with the application processing circuit 202 sending a write command 208 (on behalf of requesting host software component not specifically shown) to the host storage controller 204 via internal connection lines that identifies data to be written to the external storage device 206. The data may be identified by way of a host memory address (wherein the host memory device is not specifically shown in the figure to permit the other components to be more clearly illustrated.) The host storage controller 204 responds to the write command by sending a write command request 210 to the external storage device 206 via a storage bus (also not shown in FIG. 2) indicating the amount of data to be stored. Particular examples of write command requests and other parameters, data packets and commands that may be exchanged between the various components are provided below in connection with a JEDEC-based example.

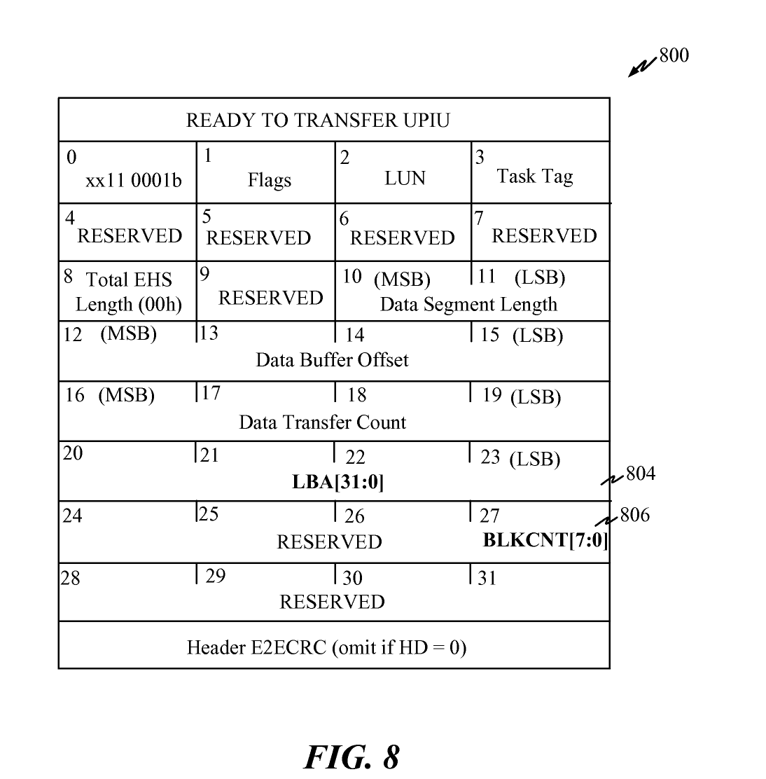

In response to the write command request, the external storage device 206 examines its memory to identify a suitable location for storing the data. The location is identified by its storage device LBA and by the number of blocks of data to be stored beginning at that LBA (i.e. the block count.) The number of blocks will depend on the amount of data to be stored and the size of individual storage blocks within the storage device. In some cases, the data will need to be stored at several different locations within the external storage device 206 and hence several LBA values and corresponding block counts may need to be identified. For clarity in describing the overall operation of the components of FIG. 2, an example is presented where only a single LBA is needed. The LBA and block count 212 are then sent from the external storage device 206 to the host storage controller 204 (along with other parameters discussed below with reference, for example, to FIG. 8.)

At 214, the host storage controller 204 generates an encryption key based on the LBA/block count and an initial key, which it either generates itself or retrieves from host memory. If the initial key is generated by the host storage controller 204, it may save the initial key in host memory for subsequent use in decryption. Exemplary encryption key generation techniques are discussed below where the LBA is employed (alone or in combination with the block count) as an initial vector for applying to an encryption function along with the initial key to generate an encryption key. At 216, the host storage controller 204 obtains the data to be stored in the external storage device from internal host memory and encrypts the data using the encryption key. The encrypted data 218 is sent to the external storage device 206 over the storage bus where it is stored, at 219, by the external storage device 206 at the LBA previously indicated. Note that the process between 212 and 219 (inclusive) may be repeated any number of times, if needed. Various acknowledgement indicators may be provided, not shown, by the storage device to the host storage controller and by the host storage controller to the application processing circuit. See below for these and other exemplary implementation details.

At a later time, the application processing circuit 202 may need to retrieve the data from the external storage device on behalf of a requesting host software component. Accordingly, the application processing circuit 202 sends a read command 220 to the host storage controller 204 that identifies data to be read from the external storage device 206. The data may again be identified by way of a host memory address. The host storage controller 204 responds to the read command by sending a read command 222 of its own to the external storage device 206 identifying the data to be retrieved. The external storage device 206 retrieves the encrypted data from its memory at 223 and sends the encrypted data and the corresponding LBA and block count, at 224, to the host storage controller 204. Again, details of an exemplary JEDEC-based implementation are presented below. At 226, the host storage controller 204 generates a decryption key for the data based on the LBA/block count and the initial key (which may be retrieved from host memory.) At 228, the host storage controller 204 decrypts the data received from the external storage device 206 using the decryption key and, at 230, writes the decrypted data to the host memory, for use by the requesting host software. Note that the process between 223 and 230 (inclusive) also may be repeated any number of times, if needed.

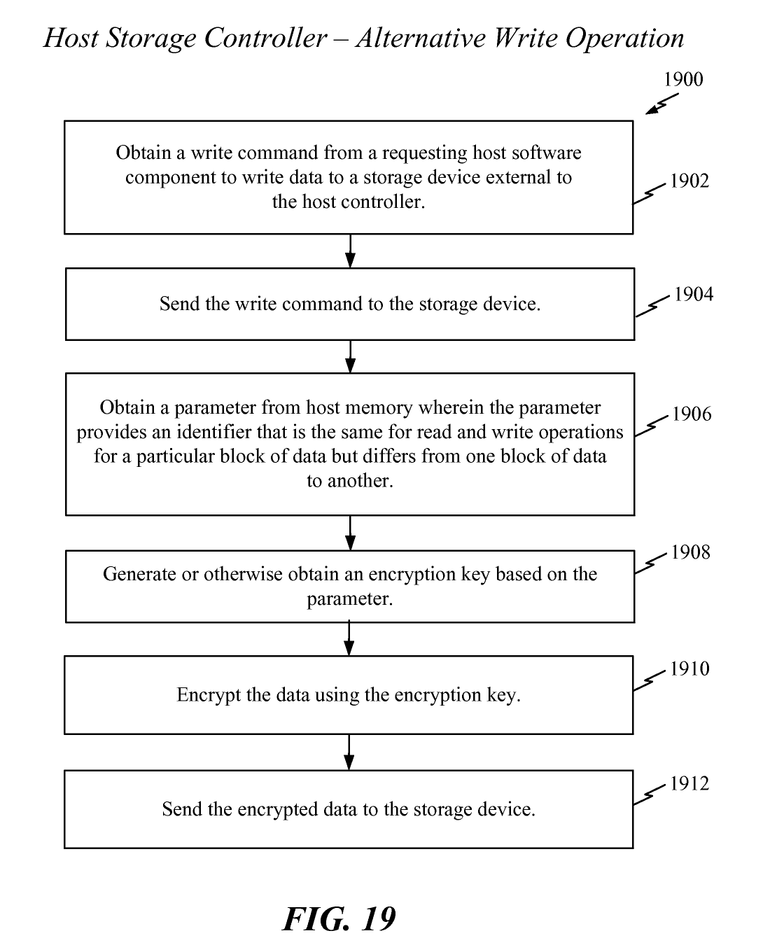

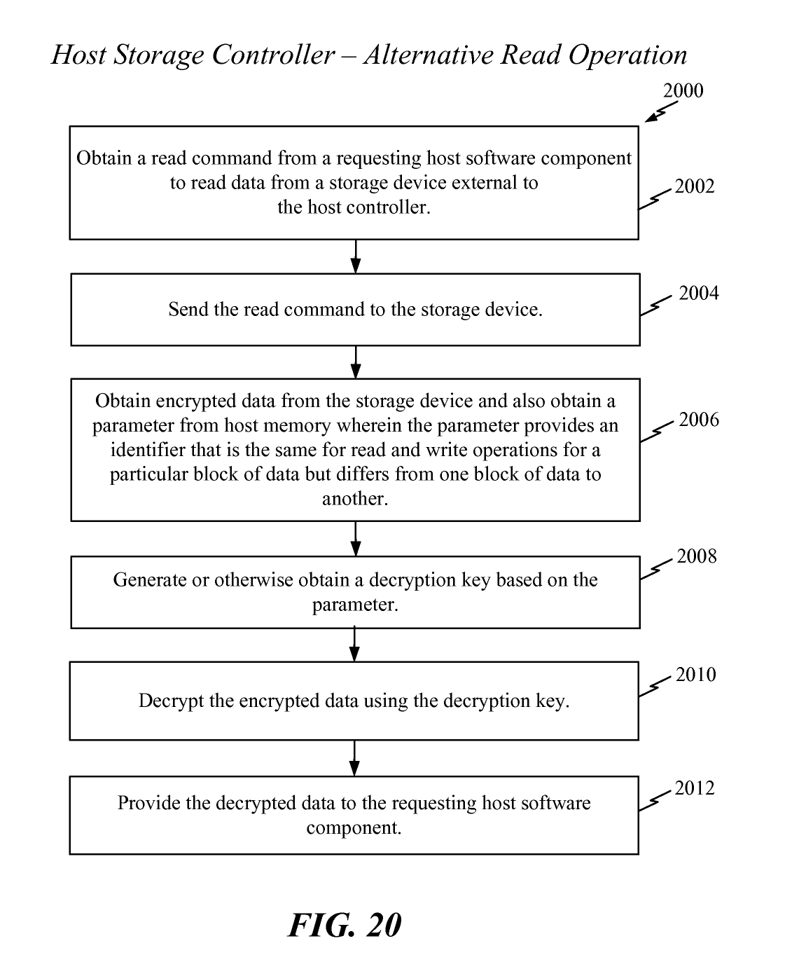

The inline encryption/decryption systems and procedures described herein can be exploited or used in a wide range of devices and for a wide range of applications. In order to provide a concrete example, an exemplary hardware environment will be described wherein a host storage controller with an inline encryption/decryption module is provided on a SoC processing circuit for use in a mobile communication device having an off-chip storage device such as a UFS device. Other exemplary hardware environments include other communication devices and components and various peripheral devices for use therewith, etc. Moreover, note that as an alternative to receiving the aforementioned parameters from the (non-secure) off-chip storage device, such parameters could instead be generated by the host storage controller and maintained in secure memory for use in encryption/decryption and such implementations are briefly described below with reference to FIGS. 19 and 20.

### Exemplary System-on-a-Chip Hardware Environment

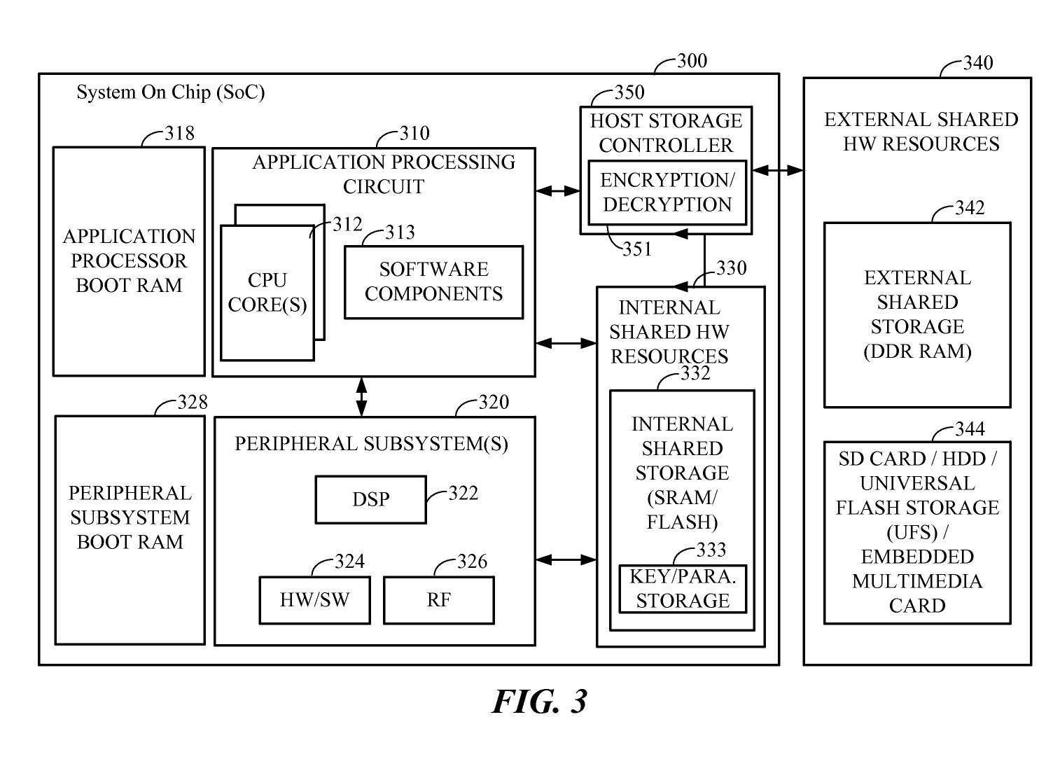

FIG. 3 illustrates a SoC processing circuit 300 of a mobile communication device in accordance with one example where various novel features may be exploited. The SoC processing circuit may be a Snapdragon™ processing circuit of Qualcomm Incorporated. The SoC processing circuit 300 includes an application processing circuit 310, which includes a multi-core CPU 312 equipped to operate in conjunction with various software components 313 (which, for clarity of illustration, are shown as a separate block from the CPU cores though it should be appreciated that the software may run within the CPU cores 312.) The application processing circuit 310 typically controls the operation of all components of the mobile communication device. In one aspect, the application processing circuit 310 is coupled to a host storage controller 350 equipped to perform inline encryption and decryption using an encryption/decryption module 351. The application processing circuit 310 may also include a boot ROM 318 that stores boot sequence instructions for the various components of the SoC processing circuit 300. The SoC processing circuit 300 further includes one or more peripheral subsystems 320 controlled by application processing circuit 310. The peripheral subsystems 320 may include but are not limited to a storage subsystem (e.g., read-only memory (ROM), random access memory (RAM)), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., other encryption components and digital rights management (DRM) components), an input/output (I/O) subsystem (e.g., keyboard, touchscreen) and wired and wireless connectivity subsystems (e.g., universal serial bus (USB), Global Positioning System (GPS), Wi-Fi, Global System Mobile (GSM), Code Division Multiple Access (CDMA), 4G Long Term Evolution (LTE) modems). The exemplary peripheral subsystem 320, which is a modem subsystem, includes a DSP 322, various other hardware (HW) and software (SW) components 324, and various radio-frequency (RF) components 326. In one aspect, each peripheral subsystem 320 also includes a boot ROM 328 that stores a primary boot image (not shown) of the associated peripheral subsystems 320.

The SoC processing circuit 300 further includes various internal shared HW resources 330, such as an internal shared storage 332 (e.g. static RAM (SRAM), double-data rate (DDR) synchronous dynamic (SD) RAM, DRAM, Flash memory, etc.), which is shared by the application processing circuit 310 and the various peripheral subsystems 320 to store various runtime data or other parameters and to provide host memory. In the example of FIG. 3, the internal shared storage 332 includes a key/parameter storage element, portion or component 333 that may be used to store encryption keys and, in some examples, to store the aforementioned parameters used by the inline encryption/decryption module 351 (particularly if those parameters are not provided by the off-chip storage device.) In other examples, keys are stored elsewhere within the mobile device or are generated as needed by the host storage controller.

In one aspect, the components 310, 318, 320, 328 and 330 of the SoC 300 are integrated on a single-chip substrate. The SoC processing circuit 300 further includes various external shared HW resources 340, which may be located on a different chip substrate and may communicate with the SoC processing circuit 300 via one or more buses. External shared HW resources 340 may include, for example, an external shared storage 342 (e.g. DDR RAM or DRAM) and/or permanent or semi-permanent data storage 344 (e.g., a Secure Digital (SD) card, Hard Disk Drive (HDD), an embedded multimedia card (e.MMC or e-MMC) device, a UFS device, etc.), which may be shared by the application processing circuit 310 and the various peripheral subsystems 320 to store various types of data, such as an operating system (OS) information, system files, programs, applications, user data, audio/video files, etc. At least some of the data stored within the external resources and devices 340 may be encrypted by the host storage controller 350 during write operations and then decrypted by the host storage controller during read operations.

When the mobile communication device incorporating the SoC processing circuit 300 is activated, the SoC processing circuit begins a system boot up process. In particular, the application processing circuit 310 accesses boot ROM 318 to retrieve boot instructions for the SoC processing circuit 300, including boot sequence instructions for the various peripheral subsystems 320. The peripheral subsystems 320 may also have additional peripheral boot RAM 328.

### Exemplary Inline Encryption/Decryption Procedures

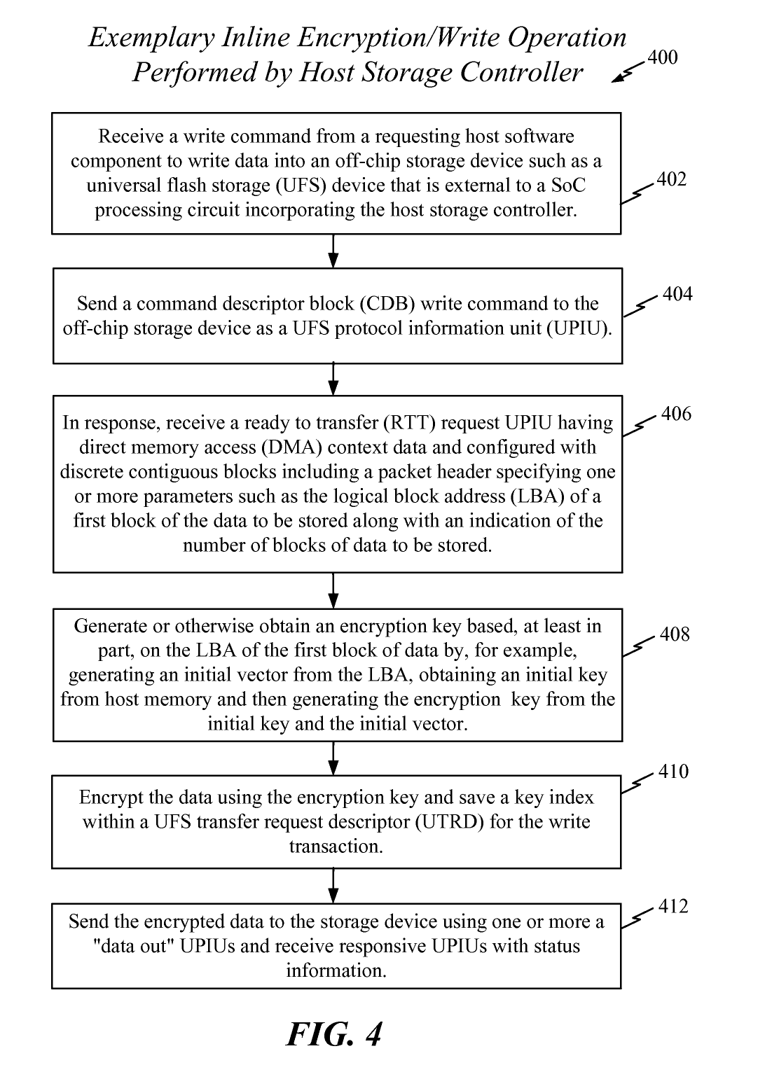

FIG. 4 illustrates exemplary inline encryption/write operations 400 that may be employed by the host storage controller of the processing circuit of FIG. 3, or other suitable-equipped components, devices, systems or processing circuits. The procedure of FIG. 4 is performed generally in accordance with JEDEC standards and protocols, modified to provide for storage device assisted inline encryption. In this example, the LBA is received from the storage device by the host storage controller for use in generating an initial vector but, as already explained, other parameters besides the LBA may instead be used. At step 402, the host storage controller receives a write command from a requesting host software component to write data into or onto an off-chip storage device such as a UFS device that is external to a SoC processing circuit incorporating the host storage controller. The write command may be received via internal SoC command transmission lines. At step 404, the host storage controller sends a command descriptor block (CDB) write command via a storage bus to the off-chip storage device with the command configured as a UFS protocol information unit (UPIU), generally in accordance with JEDEC standards. At step 406, in response, the host storage controller receives a ready to transfer (RTT) request UPIU from the off-chip storage device via the storage bus wherein the RTT request UPIU has direct memory access (DMA) context data and is configured with discrete contiguous blocks including a packet header specifying one or more parameters such as the LBA of a first block of the data to be stored along with an indication of the number of blocks of data to be stored. Note that the RTT of step 406 need not be received immediately after step 404. Rather, the RTT may be received at a later time. An exemplary RTT request UPIU is shown in FIG. 8 and described below.

At step 408, the host storage controller generates or otherwise obtains an encryption key based, at least in part, on the LBA of the first block of data and the indication of the number of blocks by, for example, using the LBA (alone or in combination with the block count) as an initial vector or by generating the initial vector from the LBA. Note that, herein, the term “obtaining” broadly covers, e.g., calculating, computing, generating, acquiring, receiving, retrieving or performing any other suitable corresponding actions. A wide variety of encryption key generation techniques may be used at step 408 depending upon the security needs of the overall system. In at least some examples, the host storage controller uses the LBA to generate an initial vector (or uses the LBA as the initial vector.) The host storage controller also obtains an initial key from host memory (such as from key storage 333 of FIG. 3.) The host storage controller then generates the encryption key from the initial key and the initial vector. For example, the initial vector and the initial key may be applied to an Advanced Encryption Standard (AES) encryption function to generate an encryption key (cipher).

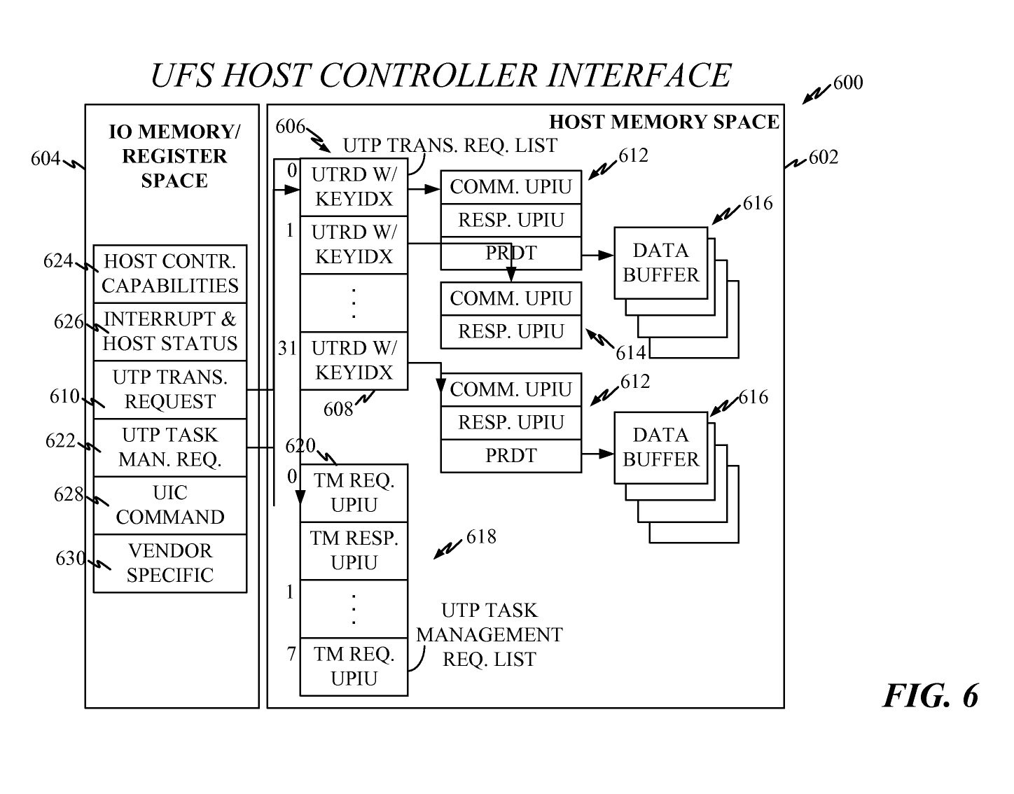

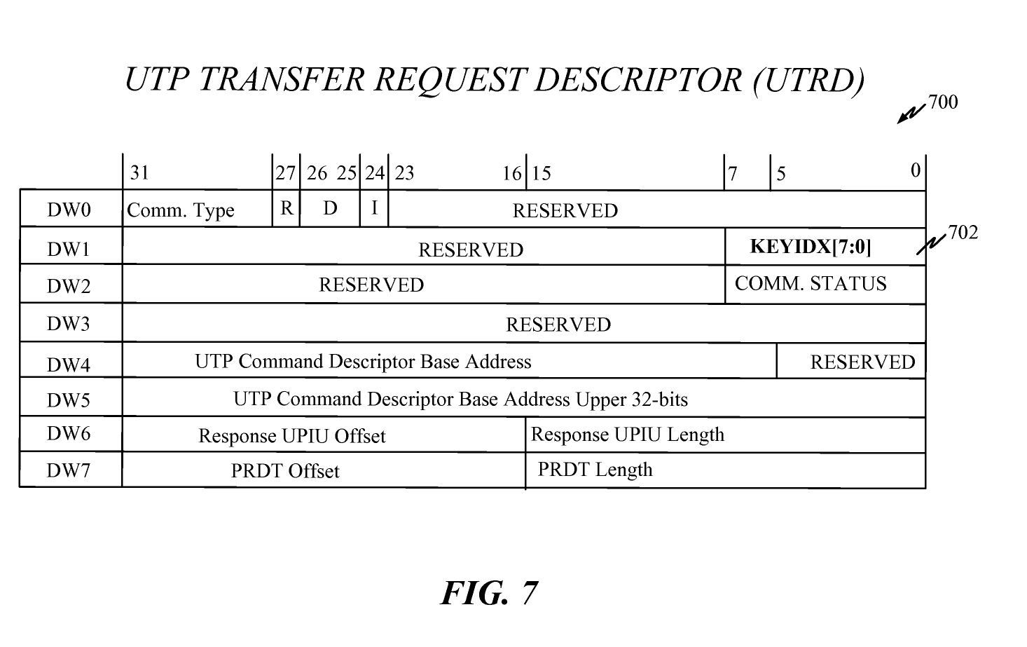

At step 410, the host storage controller encrypts the data using the encryption key. A wide variety of particular encryption techniques may be used at step 410. In an AES example, the encryption key (cipher) generated from the initial vector and the initial key may be applied one or more times to the data to be encrypted. Also at step 410, the host storage controller saves a key index within a UFS transfer request descriptor (UTRD) for the write transaction. An exemplary host memory space having a queue of UTRDs is shown in FIGS. 6 and 7 and described below for a UFS example. At step 412, the host storage controller sends the encrypted data to the storage device for storage therein via the storage bus using one or more a “data out” UPIUs and receives responsive UPIUs with status information confirming the storage of the encrypted data.

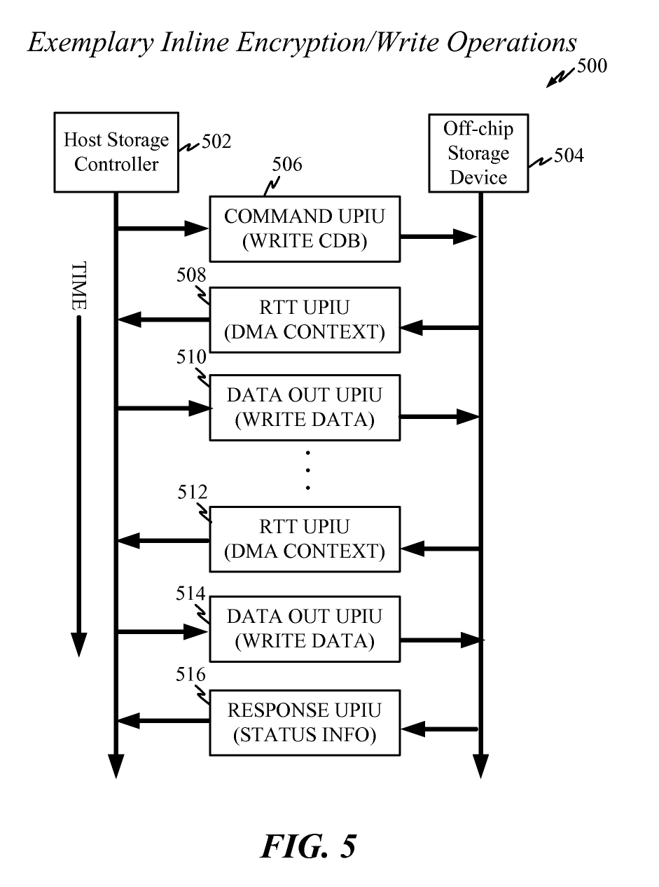

FIG. 5 further illustrates exemplary inline encryption/write operations by way of a timing diagram/flow chart 500 that shows commands and other packets exchanged between a host storage controller 502 and an off-chip storage device 504 via the aforementioned storage bus. Initially, a command UPIU 506 is transmitted from the host storage controller to the off-chip storage device containing write CDB information indicating that data needs to be written to the off-chip storage device. In response, an RTT UPIU 508 is then transmitted from the off-chip storage device to the host storage controller indicating that the off-chip storage device is ready to receive the data. As already explained, the RTT UPIU includes DMA context data and is configured with discrete contiguous blocks including a packet header specifying one or more parameters including the LBA of a first block of the data to be stored along with an indication of the number of blocks of data to be stored. Although not shown in FIG. 5, following receipt of RTT UPIU 508, the host storage controller encrypts the data to be written, as already explained. One or more data out UPIUs 510 are transmitted from the host storage controller to the off-chip storage device containing encrypted data to be stored in the off-chip storage device. In response to another RTT UPIU 512, the host storage controller sends one or more additional data out UPIUs 514 containing more encrypted data. Eventually, a response UPIU 516 containing status info is sent from the off-chip storage device to the host storage controller, generally in accordance with JEDEC UFS protocols. The response UPIU may indicate, e.g., that the data was successfully stored.

FIG. 6 illustrates the general architecture of an exemplary UFS host controller interface (HCI) that uses a memory space 600, in which various of the aforementioned parameters and commands may be stored, maintained or processed. More specifically, the figure illustrates a host memory space 602 and an input/output (IO) memory/register space 604. FIG. 6 also illustrates exemplary transaction queuing by way of various lists, commands and data buffers. As the overall features of FIG. 6 may be configured generally in accordance with JEDEC UFS standards, this figure will only be described briefly with emphasis on the UTRDs, each of which has a key index (KEYIDX.) The host memory space 602 maintains a UTP transaction request list 606 that lists UTRDs, each of which includes a KEYIDX. The UTRDs with KEYIDXs are denoted 608 in the figure. The details of an individual exemplary UTRD with a key index is shown in FIG. 7, described below. The UTRDs of FIG. 6 are received via a UTP transaction request component 610 of the IO register/memory space for queuing within UTP transaction request list 606. The UTRDs of list 606 are then used to generate corresponding command UPIUs for use with corresponding response UPIUs and physical region description tables (PRDTs), in accordance with JEDEC standards. In FIG. 6, each group of command UPIUs, response UPIUs and PRDTs are denoted 612. At least some groupings may not include a PRDT, as denoted by group 614. Data associated with the PRDTs may be stored in data buffers 616. Additionally, the host memory space 602 includes a UTP task management request list 618 for storing or queuing various TM request UPIUs 620, which are received via a UTP management request 622 of the IO register/memory space 604. For the sake of completeness, other components of the IO register/memory space 604 are noted and these include host controller capabilities 624, interrupt and host status indicators 626, UFS interconnect (UIC) commands 628 and vendor specific values 630. See the aforementioned JEDEC documents for further information regarding these and other components illustrated in FIG. 6.

FIG. 7 illustrates an exemplary UTRD 700 that includes the aforementioned key index, denoted 702. In this example, the key index is an eight-bit ID: KEYIDX[7:0]. Various other elements of the UTRD are shown for the sake of completeness such as a command type value, an overall command status value, a UTP command descriptor base address value (stored in two separate portions as shown), a response UPIU offset value, a response UPIU length value, a PRDT offset value and a PRDT length value. Again, see the aforementioned JEDEC documents for further information regarding these and other values illustrated in FIG. 7.

FIG. 8 illustrates an RTT UPIU 800 that includes the aforementioned LBA, denoted 804, and the block count, denoted 806. In this example, the LBA is a 32-bit value: LBA[31:0] and the block count is an eight-bit value: BLKCNT[7:0]. Various other elements of the RTT UPIU are shown for the sake of completeness such as a logic unit number (LUN), a total extra header segment (EHS) length, a data segment length, a data buffer offset, a data transfer count, and an end to end cyclic redundancy check (E2ECRC) header. As noted in the figure, the header may be omitted if an HD bit is 1. When set to 1, the HD bit specifies that an end-to-end CRC of all header segments is included within the UPIU. The CRC fields include all fields within the header area. The CRC is placed at the 32-bit word location following the header. End-to-end CRC is not necessarily supported in all versions of the JEDEC standard and so HD may be set to 0. See the aforementioned JEDEC documents for further information regarding these and other values illustrated in FIG. 8.

Note that rather than providing the LBA in the RTT UPIU, one or more alternative parameters could instead be provided. Generally speaking, a wide variety of parameters can be employed, particularly parameters suitable for generating an initial vector for use in encryption/decryption. In this regard, the parameters should include an identifier that is the same for read and write commands (so that data encrypted during a write operation can be easily decrypted during a subsequent read operation) and should be unique from one data block to another. The LBA is used herein as an exemplary parameter since it serves these requirements, but other values may instead be used that provide additional security features, particularly to thwart attacks that might change or corrupt the LBA.

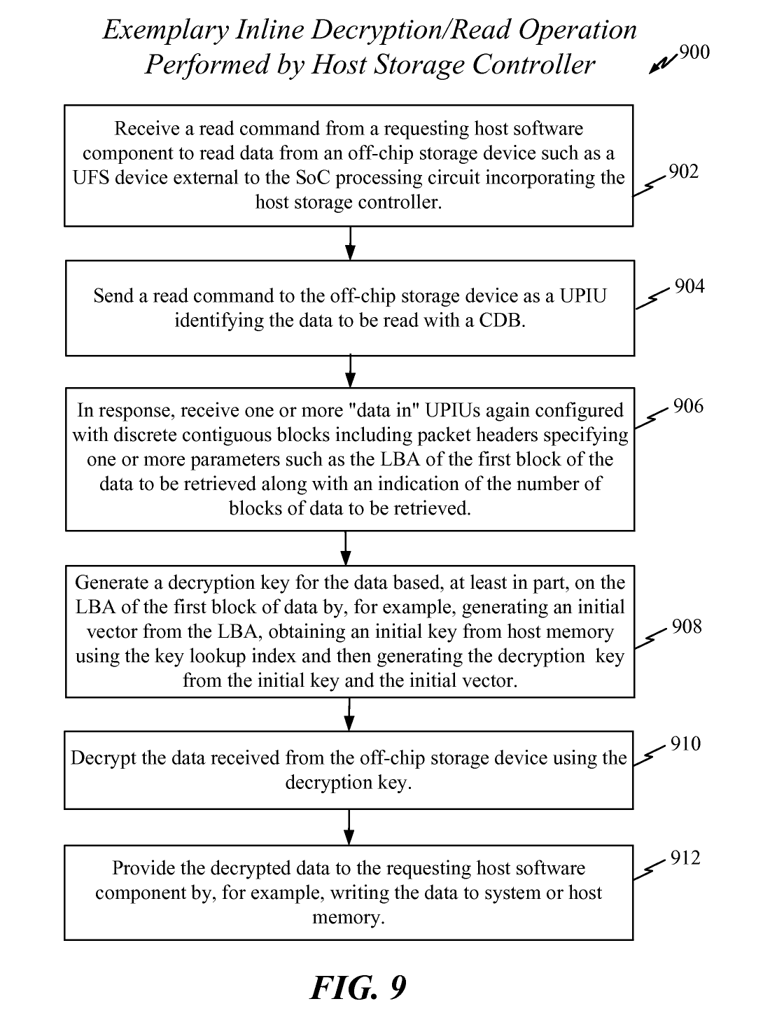

Turning now to FIGS. 9-11, inline decryption/read operations will now be described for use in reading and decrypting data previously encrypted and written to storage using the techniques of FIGS. 4-8.

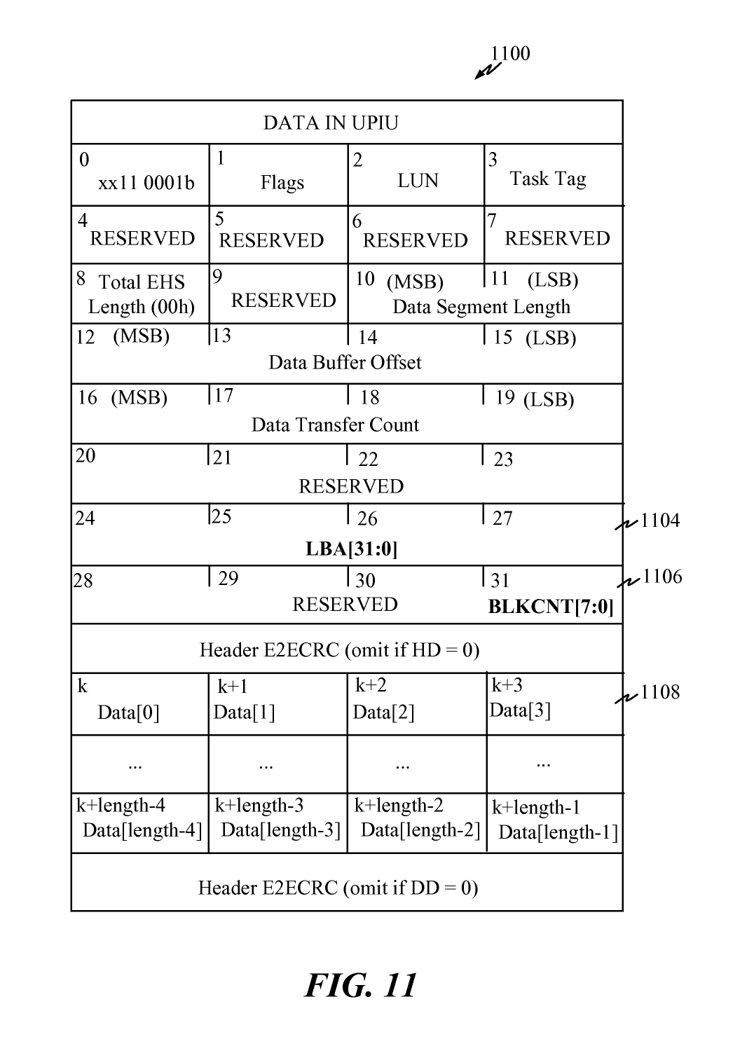

FIG. 9 illustrates exemplary inline decryption/read operations 900 that may be employed by the host storage controller of the processing circuit of FIG. 3, or other suitable-equipped components, devices, systems or processing circuits. At step 902, the host storage controller receives a read command from a requesting host software component to read data from an off-chip storage device such as a UFS device that is external to a SoC processing circuit incorporating the host storage controller. The read command may be received via internal SoC command transmission lines. At step 904, the host storage controller sends a CDB read command via the storage bus to the off-chip storage device with the command configured as a UPIU that identifies the data to be read, generally in accordance with JEDEC standards. At step 906, in response, the host storage controller receives one or more “data in” UPIUs from the off-chip storage device via the storage bus wherein the UPIUs are again configured with discrete contiguous blocks including packet headers specifying one or more parameters such as the LBA of the first block of the data to be retrieved along with an indication of the number of blocks of data to be retrieved. An exemplary data in UPIU is shown in FIG. 11 and described below.

At step 908, the host storage controller generates or otherwise obtains the decryption key for the data to be read from the key memory of the host memory of the SoC based, at least in part, on the LBA of the first block of data and the number of blocks of data in conjunction with the corresponding UTRD for the transaction (which, as already explained, includes a key index value.) In one example, the host storage controller generates an initial vector from the LBA (or uses the LBA as the initial vector), obtains the initial key from memory (in conjunction with the key index for the transaction) and then generates the decryption key from the initial key and from the initial vector. Note that, depending upon the particular type of encryption/decryption employed by the system, the decryption key might be the same key as the aforementioned encryption key, merely used for decryption instead of encryption. In some implementations, however, the decryption key may differ from the encryption key and so, for the sake of generality, separate terms are used herein for the encryption key and the decryption key. At step 910, the host storage controller decrypts the data using the decryption key. At step 912, the host storage controller provides or “sends” the decrypted data to the requesting host software component, typically by writing the data to system memory (e.g. host memory.)

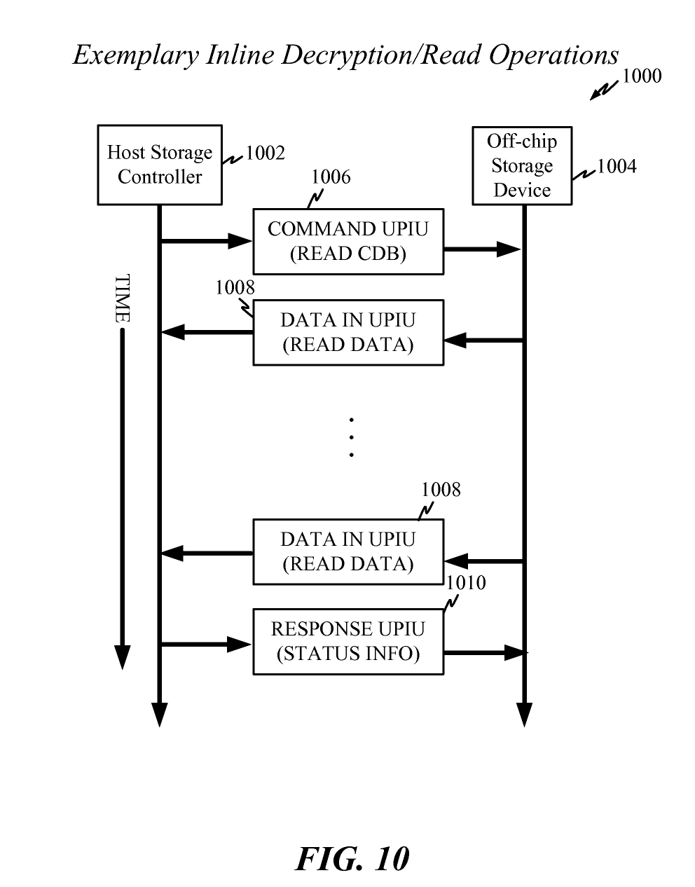

FIG. 10 further illustrates exemplary inline decryption/read operations by way of a timing diagram/flow chart 1000 that shows commands exchanged between a host storage controller 1002 and an off-chip storage device 1004 via the aforementioned storage bus. Initially, a command UPIU 1006 is transmitted from the host storage controller to the off-chip storage device containing read CDB information indicating that data needs to be read from the off-chip storage device. In response, one or more data in UPIUs 1008 are transmitted from the off-chip storage device to the host storage controller containing encrypted data. As already explained, each data in UPIU is configured with discrete contiguous blocks including a packet header specifying one or more parameters such as the LBA of a first block of the data being read along with an indication of the number of blocks of data being read. Eventually, a response UPIU 1010 containing status info is sent from the host controller to the off-chip storage device, generally in accordance with JEDEC UFS protocols. The response UPIU may indicated, e.g., that the data was successfully received by the host storage controller.

FIG. 11 illustrates an exemplary data in UPIU 1100 that includes the aforementioned LBA, denoted 1104, and block count, denoted 1106, as well as the encrypted data, which begins on line 1108 of the UPIU of the figure. Again, the LBA is a 32-bit value: LBA[31:0] and the block count is an eight-bit value: BLKCNT[7:0]. Various other elements of the UPIU are shown for the sake of completeness such as a task tag, a total EHS length, a data segment length, a data buffer offset, a data transfer count, and one or more headers containing E2ECRC values. As noted in the figure the first E2ECRC header may be omitted if an HD bit is 1. The second E2ECRC header may be omitted if a DD bit is 0. When set to 1, the DD bit specifies that an E2ECRC of the data segment is included with the UPIU. The 32-bit CRC is calculated over all the fields within the data segment and may be placed at the end of the data segment as the last word location of the UPIU. As noted, end-to-end CRC is not necessarily supported in all versions of the JEDEC standard and so DD (as well as HD) may be set to 0. See the aforementioned JEDEC documents for further information regarding these and other values illustrated in FIG. 11. Upon receipt of the UPIU, the host storage controller extracts the encrypted data from the packet and employs the LBA and BLKCNT values to obtain or generate the decryption key for decrypting the data. The LBA may be used as an initial vector to obtain or generate the decryption key for the data contained in the data in UPIU. As already noted, other parameters may be used besides, or in addition to, the LBA. If other parameters are used, the parameters should be selected and employed so that the parameters provide an identifier that will be the same for read and write operations for a particular block of data (to allow the host storage controller to decrypt data that had previously been encrypted) but will differ from one block of data to another (to provide uniqueness.)

### Exemplary Systems and Methods

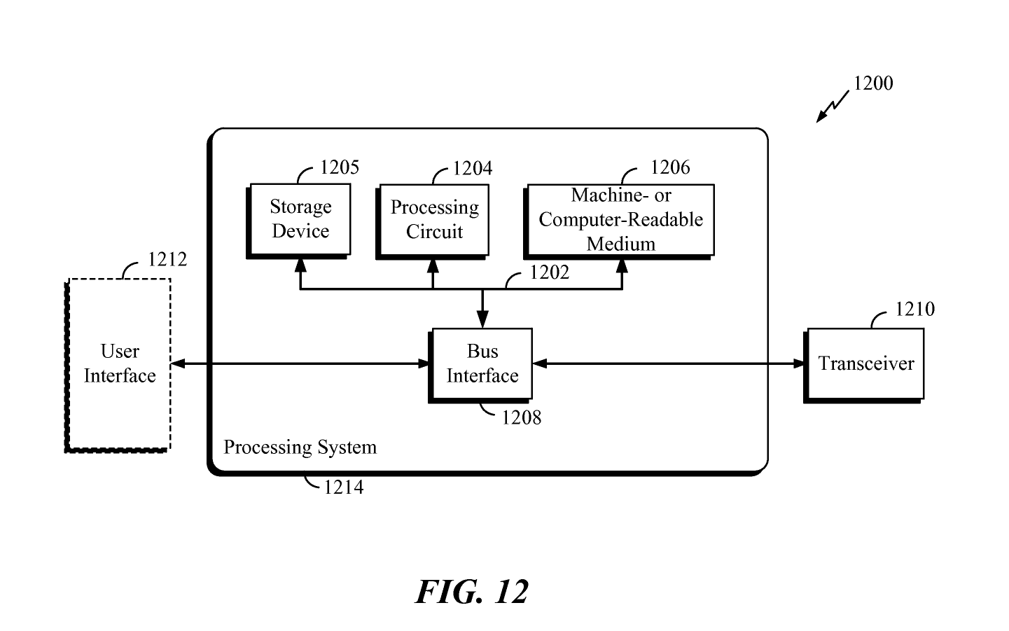

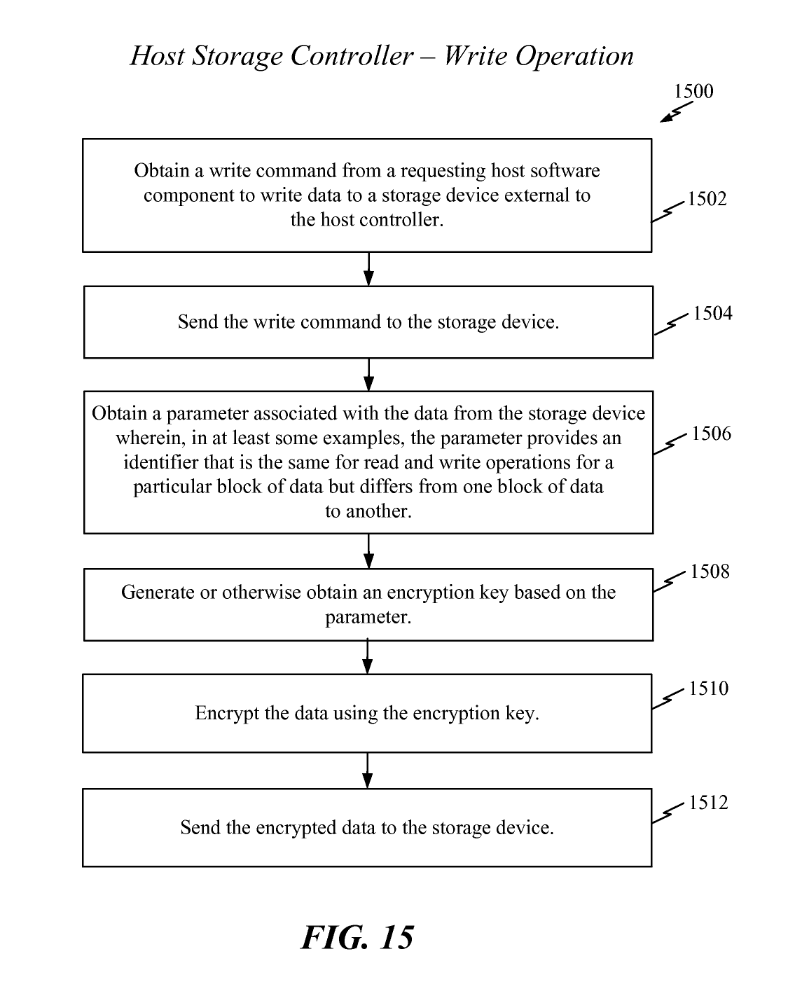

FIG. 12 illustrates an overall system or apparatus 1200 in which the systems, methods and apparatus of FIGS. 2-11 may be implemented. In accordance with various aspects of the disclosure, an element, or any portion of an element, or any combination of elements may be implemented with a processing system 1214 that includes one or more processing circuits 1204 such as the SoC processing circuit of FIG. 3. For example, apparatus 1200 may be a user equipment (UE) of a mobile communication system. Apparatus 1200 may be used with a radio network controller (RNC). In addition to an SoC, examples of processing circuits 1204 include microprocessing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. That is, the processing circuit 1204, as utilized in the apparatus 1200, may be used to implement any one or more of the processes described above and illustrated in FIGS. 2-12 (and those illustrated in FIGS. 15-20, discussed below), such as processes to perform inline encryption and decryption of data within the storage device 1205.

In the example of FIG. 12, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links various circuits including one or more processing circuits (represented generally by the processing circuit 1204), the storage device 1205, and a machine-readable, processor-readable, processing circuit-readable or computer-readable media (represented generally by a non-transitory machine-readable medium 1206.) The bus 1202 may also link various other circuits such as timing sources, peripherals, voltage regulators, and power management circuits, which are well known in the art, and therefore, will not be described any further. The bus interface 1208 provides an interface between bus 1202 and a transceiver 1210. The transceiver 1210 provides a means for communicating with various other apparatus over a transmission medium. Depending upon the nature of the apparatus, a user interface 1212 (e.g., keypad, display, speaker, microphone, joystick) may also be provided.

The processing circuit 1204 is responsible for managing the bus 1202 and for general processing, including the execution of software stored on the machine-readable medium 1206. The software, when executed by processing circuit 1204, causes processing system 1214 to perform the various functions described herein for any particular apparatus. Machine-readable medium 1206 may also be used for storing data that is manipulated by processing circuit 1204 when executing software.

One or more processing circuits 1204 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 1206. The machine-readable medium 1206 may be a non-transitory machine-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer. The machine-readable medium 1206 may reside in the processing system 1214, external to the processing system 1214, or distributed across multiple entities including the processing system 1214. The machine-readable medium 1206 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

For example, the machine-readable storage medium 1206 may have one or more instructions which when executed by the processing circuit 1204 causes the processing circuit to: receive a write command from a requesting host software component to write data to the storage device; send the write command to the storage device; receive a parameter associated with data from the storage device; generate an encryption key based on the parameter; and encrypt the data using the encryption key. As another example, the machine-readable storage medium 1206 may have one or more instructions which when executed by the processing circuit 1204 causes the processing circuit to: receive a read command from a requesting host software component to obtain data from the storage device; send the read command to the storage device; receive encrypted data and a parameter associated with the encrypted data from the storage device; obtain a decryption key based on the parameter; and decrypt the encrypted data using the decryption key.

One or more of the components, steps, features, and/or functions illustrated in the figures may be rearranged and/or combined into a single component, step, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a digital signal processing circuit (DSP), an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 300 and/or 1204 illustrated in FIGS. 3 and 12 may be a specialized processing circuit (e.g., an ASIC)) that is specifically designed and/or hard-wired to perform the algorithms, methods, and/or steps described in FIGS. 4, 5, 9 and/or 10 (and/or FIGS. 15, 16, 17, 18, 19 and/or 20 discussed below.) Thus, such a specialized processing circuit (e.g., ASIC) may be one example of a means for executing the algorithms, methods, and/or steps described in FIGS. 4, 5, 9 and/or 10 (and/or FIGS. 15, 16, 17, 18, 19 and/or 20, discussed below.) The machine-readable storage medium may store instructions that when executed by a specialized processing circuit (e.g., ASIC) causes the specialized processing circuit to perform the algorithms, methods, and/or steps described herein.

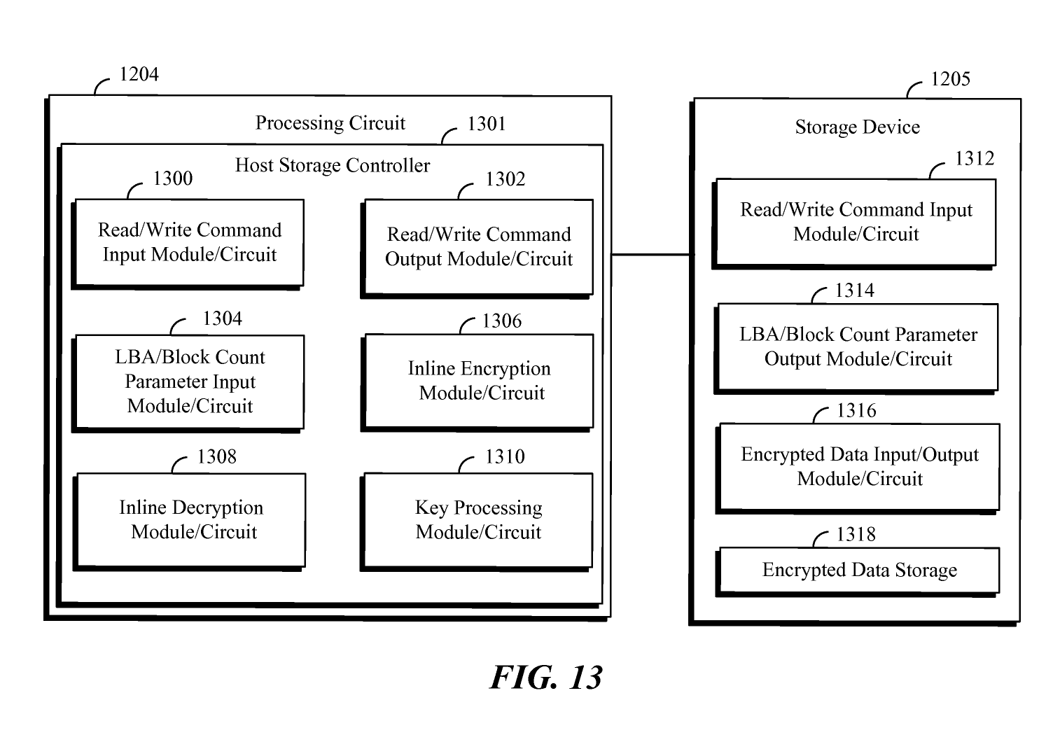

FIG. 13 illustrates selected and exemplary components of processing circuit 1204 having a host storage controller 1301 for use with storage device 1205. In particular, the host storage controller 1301 of FIG. 13 includes a read/write command input module/circuit 1300 operative to obtain write commands from a requesting host software component (not shown in the figure) for writing data to the storage device and also operative to obtain read commands from the requesting host software component for reading data from the storage device. The host storage controller 1301 also includes: a read/write command output module/circuit 1302 operative to send read and write commands to the storage device 1205 and an LBA/block count parameter input module/circuit 1304 operative to obtain one or more parameters associated with data to be read/written to/from the storage device such as an LBA and a block count or other suitable parameters. The host storage controller 1301 also includes: an inline encryption module/circuit 1306 operative to encrypt data using the host storage controller for storage in the storage device and an inline decryption module/circuit 1308 operative to decrypt data received from storage device. Still further the host storage controller 1301 includes: a key processing module/circuit operative to obtain or otherwise generate encryption/decryption keys based, at least in part, on the LBA or other parameters obtained by the parameter input module/circuit 1304.

The storage device 1205 of FIG. 13 includes a read/write command input module/circuit 1312 operative to receive read and/or write commands from the host storage controller 1301 indicating encrypted data to be read/written. An LBA/block count parameter output module/circuit 1314 is operative to output one or more parameters associated with data to be read/written such as the LBA and the block count to facilitate inline encryption/decryption of data within the host storage controller 1301. The storage device 1205 also includes an encrypted data input/output module/circuit operative to receive encrypted data from the host storage controller 1301 (in conjunction with a write command) and to output encrypted data to the host storage controller 1301 (in conjunction with a read command.) An encrypted data storage unit 1318 stores the encrypted data.

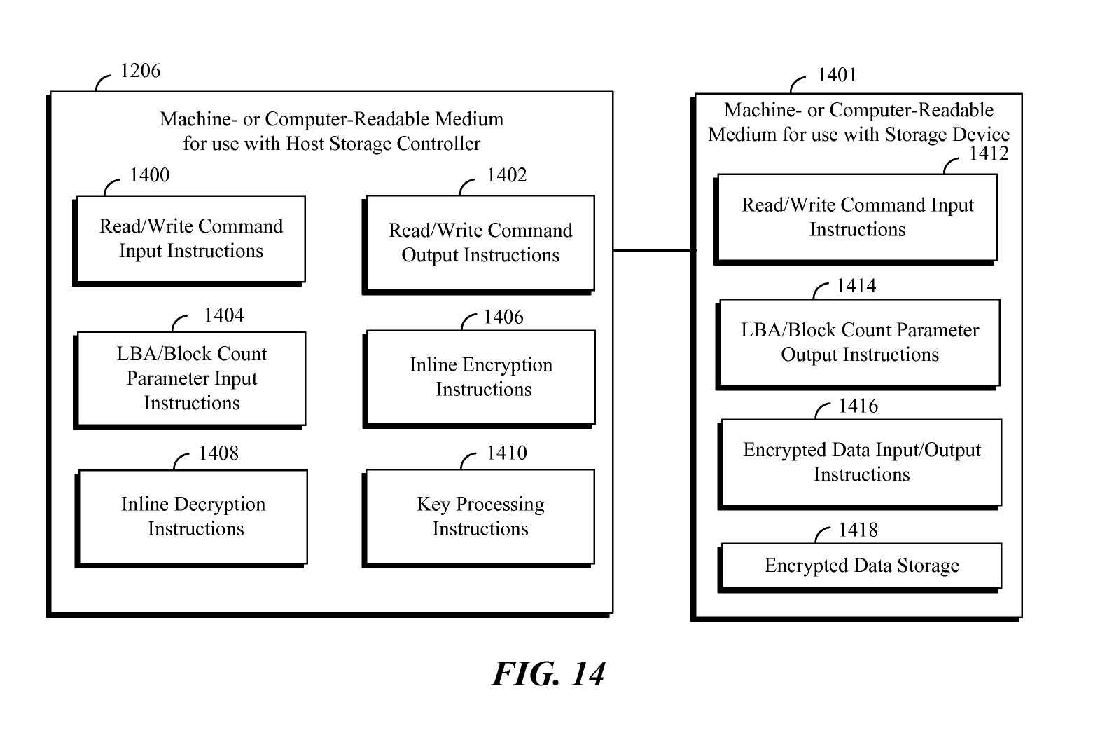

FIG. 14 illustrates selected and exemplary instructions of the machine-readable, computer-readable or processing circuit-readable medium 1206 for use with a host storage controller such as the host storage controller 1301 of the processing circuit 1204 of FIG. 12. The figure also illustrates selected and exemplary instructions of a machine-readable, computer-readable or processing circuit-readable medium 1401 for use with a storage device such as device 1205 of FIG. 12. Briefly, the machine-readable medium 1206 of FIG. 14 includes various instructions, which when executed by the host storage controller 1301 of FIG. 12, cause the host storage controller to control or perform inline encryption/decryption operations. In particular, read/write command input instructions 1400 are operative to cause the host storage controller to obtain write commands from a requesting host software component (not shown in the figure) to write data to the storage device and also instructions operative to cause the host storage controller to obtain read commands from the requesting host software component to read data from the storage device. The machine-readable medium 1206 also includes: read/write command output instructions 1402 operative to cause the host storage controller to send read and write commands to the storage device 1205 and LBA/block count parameter input instructions 1404 operative to cause the host storage controller to obtain one or more parameters associated data to be read/written to/from the storage device such as an LBA and a block count. The machine-readable medium 1206 also includes: inline encryption instructions 1406 operative to cause the host storage controller to encrypt data using a host storage controller for storage in the storage device and inline decryption instructions 1408 operative to cause the host storage controller to decrypt data received from storage device. Still further the machine-readable medium 1206 includes: key processing instructions operative to cause the host storage controller to obtain or otherwise generate encryption/decryption keys based, at least in part, on the LBA or other parameters obtained by execution of the parameter input instructions 1404.

The machine-readable medium 1401 of FIG. 14 for use with the storage device of FIG. 12 includes read/write command input instructions 1412, which when executed by the circuitry of the storage device, cause the storage device to receive read and/or write commands from the host storage controller 1301 of FIG. 12 indicating encrypted data to be read/written. LBA/block count parameter output instructions 1414 are operative to cause the storage device to output one or more parameters associated with data to be read/written such as the LBA and the block count to facilitate inline encryption/decryption of data within the host storage controller. The machine-readable medium 1401 also includes encrypted data input/output instructions operative to cause the storage device to receive encrypted data from the host storage controller (in conjunction with a write command) and to output encrypted data to the host storage controller (in conjunction with a read command.) An encrypted data storage unit 1418 stores the encrypted data.

FIG. 15 broadly illustrates and summarizes methods or procedures 1500 that may be performed by the host storage controller 1301 of the processing circuit 1204 of FIG. 12 or other suitably equipped devices for inline encryption of data during a write operation. At step 1502, the host storage controller obtains a write command from a requesting host software component to write data to the storage device. At step 1504, the host storage controller sends the write command to the storage device. At step 1506, the host storage controller obtains a parameter associated with the data from the storage device wherein, in at least some examples, the parameter provides an identifier that is the same for read and write operations for a particular block of data but differs from one block of data to another. At step 1508, the host storage controller generates or otherwise obtains an encryption key based on the parameter and, at step 1510, encrypts the data using the encryption key. At step 1512, the host storage controller sends the encrypted data to the storage device.

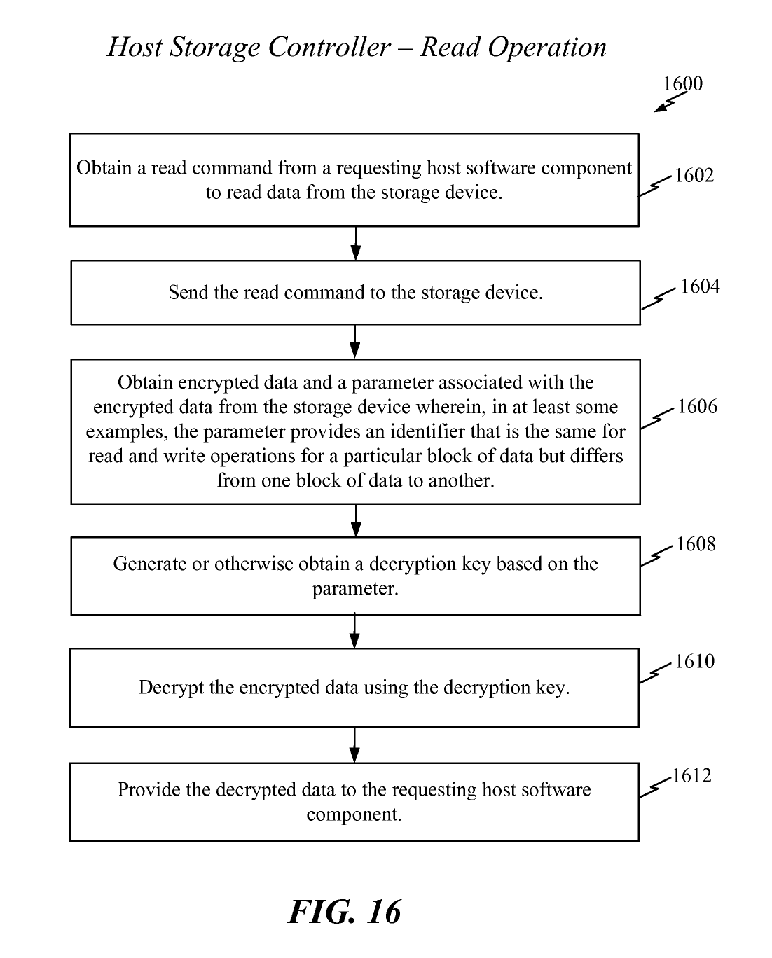

FIG. 16 broadly illustrates and summarizes methods or procedures 1600 that may be performed by the host storage controller 1301 of the processing circuit 1204 of FIG. 12 or other suitably equipped devices for inline decryption of data during a read operation. At step 1602, the host storage controller obtains a read command from a requesting host software component to read data from the storage device. At step 1604, the host storage controller sends the read command to the storage device. At step 1606, the host storage controller obtains encrypted data and a parameter associated with the encrypted data from the storage device wherein, in at least some examples, the parameter provides an identifier that is the same for read and write operations for a particular block of data but differs from one block of data to another. At step 1608, the host storage controller generates or otherwise obtains a decryption key based on the parameter and, at step 1610, decrypts the encrypted data using the decryption key. At step 1612, the host storage controller provides or “sends” the decrypted data to the requesting host software component.

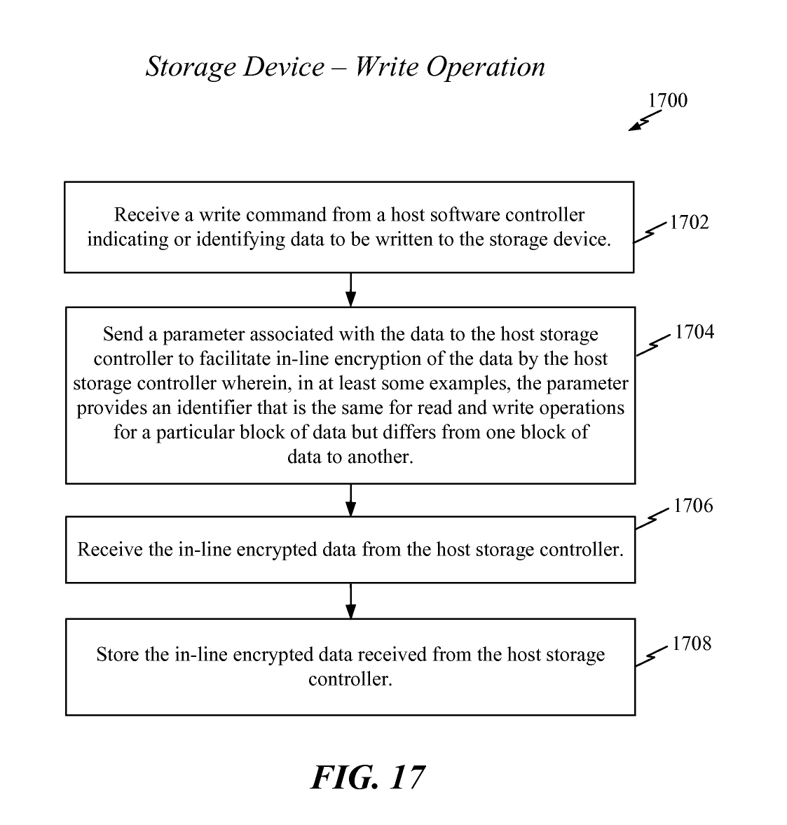

FIG. 17 broadly illustrates and summarizes methods or procedures 1700 that may be performed by the storage device 1205 of FIG. 12 or other suitably equipped devices for receiving and storing encrypted data from a host storage controller as part of a write operation. At step 1702, the storage device receives a write command from a host software controller indicating data to be written to the storage device. At step 1704, the host storage device sends a parameter associated with the data to the host storage controller to facilitate in-line encryption of the data by the host storage controller wherein, in at least some examples, the parameter provides an identifier that is the same for read and write operations for a particular block of data but differs from one block of data to another. At step 1706, the storage device receives the in-line encrypted data from the host storage controller and, at step 1708, stores the in-line encrypted data received from the host storage controller.

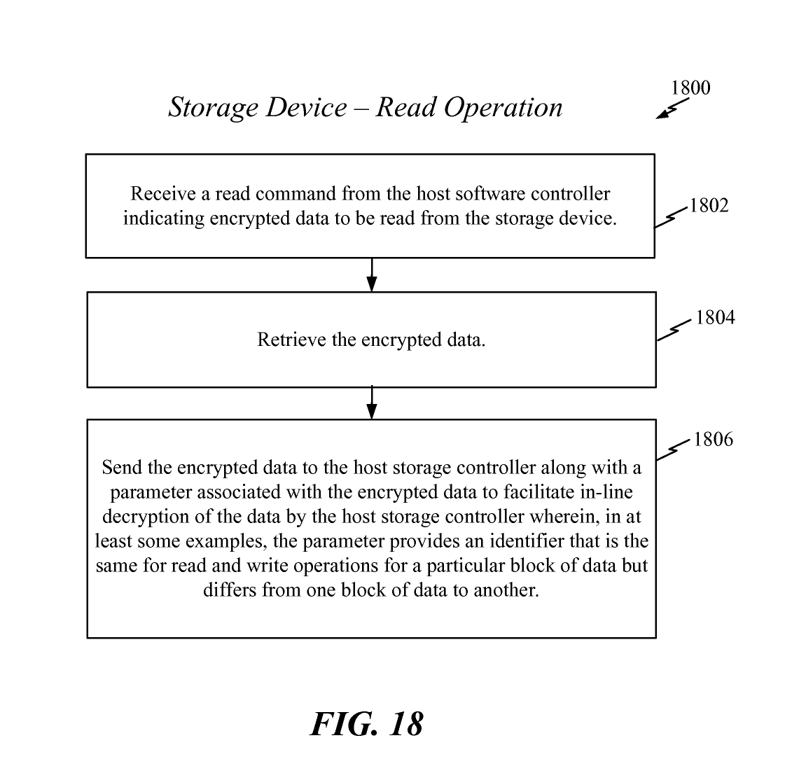

FIG. 18 broadly illustrates and summarizes methods or procedures 1800 that may be performed by the storage device 1205 of FIG. 12 or other suitably equipped devices for retrieving and sending encrypted data to a host storage controller as part of a read operation. At step 1802, the storage device receives a read command from a host software controller indicating encrypted data to be read from the storage device. At step 1804, the host storage retrieves the encrypted data. At step 1806, the storage device sends the encrypted data to the host storage controller along with a parameter associated with the encrypted data to facilitate in-line decryption of the data by the host storage controller wherein, in at least some examples, the parameter provides an identifier that is the same for read and write operations for a particular block of data but differs from one block of data to another.

FIG. 19 broadly illustrates and summarizes alternative methods or procedures 1900 that may be performed by the host storage controller 1301 of the processing circuit 1204 of FIG. 12 or other suitably equipped devices for inline encryption of data during a write operation for use in implementations wherein the host storage controller does not receive the aforementioned parameters from the storage device from which encryption keys are generated. At step 1902, the host storage controller obtains a write command from a requesting host software component to write data to the storage device. At step 1904, the host storage controller sends the write command to the storage device. At step 1906, the host storage controller obtains a parameter from host memory wherein the parameter provides an identifier that is the same for read and write operations for a particular block of data but differs from one block of data to another. At step 1908, the host storage controller generates or otherwise obtains an encryption key based on the parameter and, at step 1910, encrypts the data using the encryption key. At step 1912, the host storage controller sends the encrypted data to the storage device.

FIG. 20 broadly illustrates and summarizes alternative methods or procedures 2000 that may be performed by the host storage controller 1301 of the processing circuit 1204 of FIG. 12 or other suitably equipped devices for inline decryption of data during a read operation for use in implementations wherein the host storage controller does not receive the aforementioned parameters from the storage device from which decryption keys are generated. At step 2002, the host storage controller obtains a read command from a requesting host software component to read data from the storage device. At step 2004, the host storage controller sends the read command to the storage device. At step 2006, the host storage controller obtains encrypted data from the storage device and also obtains a parameter from host memory wherein the parameter provides an identifier that is the same for read and write operations for a particular block of data but differs from one block of data to another. At step 2008, the host storage controller generates or otherwise obtains a decryption key based on the parameter and, at step 2010, decrypts the encrypted data using the decryption key. At step 2012, the host storage controller provides or “sends” the decrypted data to the requesting host software component, typically by writing the data to host memory.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational at a host storage controller to encrypt data during a write operation to a storage device external to the host storage controller, comprising:
obtaining a write command from a requesting host software component to write data to the storage device;
sending the write command to the storage device;
obtaining a parameter associated with the data from the storage device;
generating an encryption key based on the parameter; and
encrypting the data using the encryption key.

2. The method of claim 1, further comprising sending the encrypted data to the storage device.

3. The method of claim 1, wherein the parameter associated with the data provides an identifier that is the same for read and write operations for a particular block of data but differs from one block of data to another.

4. The method of claim 3, wherein the parameter associated with the data comprises a logical block address (LBA) for the data to be stored.

5. The method of claim 3, wherein the parameter associated with the data further comprises an indication of a number of blocks in the data.

6. The method of claim 3, wherein the parameter associated with the data is received from the storage device in a ready to transfer (RTT) request data packet.

7. The method of claim 6, wherein the storage device is a universal flash storage (UFS) device and wherein the parameter associated with the data is received in a data packet comprising an RTT UFS protocol information unit (UPIU).

8. The method of claim 1, further comprising maintaining a transfer request list including a transfer request descriptor having a key index associated with an individual write transaction.

9. The method of claim 1, wherein generating the encryption key comprises:
generating an initial vector from the parameter obtained from the storage device;
obtaining an initial key; and
generating the encryption key from the initial key and the initial vector.

10. The method of claim 1, wherein the host storage controller is a component of a system-on-a-chip (SoC) and the storage device is an off-chip storage device external to the SoC and wherein the host storage controller performs in-line data encryption of the data for storage in the off-chip storage device.

11. A method operational at a host storage controller to decrypt data during a read operation from a storage device external to the host storage controller, comprising:
obtaining a read command from a requesting host software component to read data from the storage device;
sending the read command to the storage device;
obtaining encrypted data and a parameter associated with the encrypted data from the storage device;
generating a decryption key based on the parameter; and
decrypting the encrypted data using the decryption key.

12. The method of claim 11, further comprising providing the decrypted data to the requesting host software component.

13. The method of claim 11, wherein the parameter associated with the data provides an identifier that is the same for read and write operations for a particular block of data but differs from one block of data to another.

14. The method of claim 11, wherein the parameter associated with the encrypted data comprises a logical block address (LBA) for the data to be read.

15. The method of claim 13, wherein the parameter associated with the encrypted data further comprises an indication of a number of blocks in the encrypted data.

16. The method of claim 13, wherein the parameter associated with the encrypted data is received from the storage device in a protocol information unit.

17. The method of claim 16, wherein the storage device is a universal flash storage (UFS) device and wherein the parameter associated with the encrypted data is received in a data packet comprising a UFS protocol information unit (UPIU).

18. The method of claim 15, further comprising maintaining a transfer request list including a transfer request descriptor having a key index associated with an individual read transaction.

19. The method of claim 11, wherein generating the decryption key comprises:
generating an initial vector from the parameter obtained from the storage device;
obtaining an initial key; and
generating the decryption key from the initial key and the initial vector.

20. The method of claim 11, wherein the host storage controller is a component of a system-on-a-chip (SoC) and the storage device is an off-chip storage device external to the SoC and wherein the host storage controller performs in-line data decryption of encrypted data received from the off-chip storage device.

21. A device comprising:
a storage device to store data;
a processing circuit coupled to the storage device, the processing circuit having a host storage controller configured to
obtain a write command from a requesting host software component to write data to the storage device;
send the write command to the storage device;
obtain a parameter associated with the data from the storage device;
generate an encryption key based on the parameter; and
encrypt the data using the encryption key.

22. The device of claim 21, wherein the host storage controller is further configured to send the encrypted data to the storage device.

23. The device of claim 21, wherein the parameter associated with the data provides an identifier that is the same for read and write operations for a particular block of data but differs from one block of data to another.

24. The device of claim 23, wherein the parameter associated with the data further comprises an indication of a number of blocks in the data.

25. The device of claim 21, wherein the host storage controller is a component of a system-on-a-chip (SoC) and the storage device is an off-chip storage device external to the SoC and wherein the host storage controller is configured to perform in-line data encryption of the data for storage in the off-chip storage device.

26. A device comprising:
a storage device to store data;
a processing circuit coupled to the storage device, the processing circuit having a host storage controller configured to
obtain a read command from a requesting host software component to read data from the storage device;
send the read command to the storage device;
obtain encrypted data and a parameter associated with the encrypted data from the storage device;
generate a decryption key based on the parameter; and
decrypt the encrypted data using the decryption key.

27. The device of claim 26, wherein the host storage controller is further configured to provide the decrypted data to the requesting host software component.

28. The device of claim 26, wherein the parameter associated with the data provides an identifier that is the same for read and write operations for a particular block of data but differs from one block of data to another.

29. The device of claim 28, wherein the parameter associated with the encrypted data further comprises an indication of a number of blocks in the encrypted data.

30. The device of claim 26, wherein the host storage controller is a component of a system-on-a-chip (SoC) and the storage device is an off-chip storage device external to the SoC and wherein the host storage controller is configured to perform in-line data decryption of encrypted data received from the off-chip storage device.
